(19) United States
(12) Patent Application Publication
(10) Pub. No.: US 2003/0216064 A1
(43) Pub. Date: Nov. 20, 2003

(54) Optical module

(76) Inventor: Satoshi Yoshikawa, Yokohama-shi (JP)

Correspondence Address: MCDERMOTT WILL & EMERY, 600 13TH STREET, N.W., WASHINGTON, DC, 20005-3096, US

(21) Appl. No.: 10/409,595

(22) Filed: Apr. 9, 2003

(30) Foreign Application Priority Data
Apr. 9, 2002 (JP) P2002-106870

(51) Int. Cl. H01R 12/00

(52) U.S. Cl. 439/76.1

(57) ABSTRACT

An optical module includes an internal board with a connector terminal, and a housing for accommodating the internal board. The optical module is mounted on an external board by mating the connector terminal with another connector terminal on the external board. A module removing tool for removing the optical module from the external board has an engaging portion able to fit together with an engageable portion of the module. As the tool is rotated while the engaging portion fits together with the engageable portion of the module, the engaging portion lifts the housing of the module. This results in removing the module from the external board.

### BACKGROUND OF THE INVENTION

1. Field of the Invention

The present invention relates to an optical module.

2. Related Background Art

An optical module such as are optical transceiver module includes, for example, a light emitting module incorporating a light emitting device such as a semiconductor laser, a light receiving module incorporating a light receiving device such as a photodiode, and a component such as a semiconductor circuit element for driving and controlling the light emitting module. These components are mounted on a board. The board is encased in a housing made of metal or the like. The board has a connector terminal. The connector terminal mounted on the board is coupled to a connector terminal on an external board, whereby the optical module is mounted on the external board. The coupling between the connector terminals is arranged to be tight enough not to dismount the optical module from the external board by impact or the like.

However, for dismounting the optical module from the external board, the tight fitting between the connector terminals does not allow easy removal of the optical module. Forcible removal of the optical module could break the connector terminals. Particularly, when the direction of insertion and removal of the connector terminal is restricted, a force will result in degrading the performance of the connector terminals. This applies to connector terminals of the so-called zipper type in which the connector terminals are first mated or removed on one side and thereafter mated or removed on the other side.

### SUMMARY OF THE INVENTION

An object of the present invention is to facilitate removal of an optical module from an external board.

An aspect of the present invention is to provide an optical module, which is adapted to be mounted on an external board with a first connector terminal and is removed from the external board by using a module removing tool including an engaging portion. The optical module comprises an internal board with a second connector terminal mating with the first connector terminal, and a housing for enclosing the internal board. The housing has an opening surrounding the second connector terminal, and an engageable portion provided on the periphery of the opening. The engageable portion is able to fit together with the engaging portion of the module removing tool.

Since the engageable portion is provided on the periphery of the opening, an appropriate force can be exerted on the second connector terminal in the opening by fitting the engaging portion of the module removing tool together with the engageable portion and then operating the module removing tool. As a consequence, the fitting between the second connector terminal and the first connector terminal of the external board can be readily released, whereby the optical module can be removed from the external board.

The second connector terminal may be configured to be unmated from the first connector terminal along an unmating direction from one end to the other end of the second connector terminal. The engageable portion may be formed so that the second connector terminal is unmated from the first connector terminal along the unmating direction as one end of the module removing tool is rotated while the engaging portion of the tool fits together with the engageable portion.

This prevents unmating along a direction different from the unmating direction, and therefore prevents breakage of the first and second connector terminals.

The engageable portion may be formed on a virtual line extending along the unmating direction through the opposite ends of the second connector terminal. The virtual line may pass the middle of the second connector terminal. A pair of the engageable portions may be placed on the virtual line it the opposite sides of the second connector terminal.

The engageable portion may be a depression provided in a surface of the housing. The internal board may further include a light emitting module and/or a light receiving module.

The housing may include an upper part and a lower part having a base. The internal board is sandwiched between the upper and lower parts. The base of the lower part may be brought into contact with the external board when the optical module is mounted on the external board. The second connector terminal passes through the opening. The opening may be a through hole provided in the base of the lower part.

### BRIEF DESCRIPTION OF THE DRAWINGS

FIG. 1 is a perspective view showing an optical transceiver module according to an embodiment.

FIG. 2 is an exploded perspective view showing the optical transceiver module according to the embodiment.

FIG. 3 is a partial plan view showing the optical transceiver module according to the embodiment.

FIG. 4 is a cross-sectional view showing the optical transceiver module according to the embodiment.

FIG. 5 and FIG. 6 are perspective views showing how to assemble the optical transceiver module according to the embodiment.

FIG. 7 is a perspective view showing a first embodiment of a module removing tool.

FIG. 8 is a perspective views for explaining the procedure of removing the optical transceiver module using the module removing tool according to the first embodiment.

FIG. 9 is a cross-sectional view for explaining the procedure of removing the optical transceiver module using the module removing tool according to the first embodiment.

FIG. 10 is a perspective vies for explaining the procedure of removing the optical transceiver module using the module removing tool according to the first embodiment.

FIG. 11 is a perspective view showing a module removing tool according to a second embodiment.

FIG. 12 is a cross-sectional view for explaining the procedure of removing the optical transceiver module using the module removing tool according to the second embodiment.

FIG. 13 is a perspective view showing a module removing tool according to a third embodiment.

FIG. 14 is a perspective view for explaining the procedure of removing the optical transceiver module using the module removing tool according to the third embodiment.

FIG. 15 is a perspective view for explaining the procedure of removing the optical transceiver module using the module removing tool according to the third embodiment.

FIG. 16 is a plan view for explaining the procedure of removing the optical transceiver module using the module removing tool according to the third embodiment.

FIG. 17 is a cross-sectional view for explaining the procedure of removing the optical transceiver module using the module removing tool according to the third embodiment.

FIG. 18 is a cross-sectional view for explaining the procedure of removing the optical transceiver module using the module removing tool according to the third embodiment.

### DETAILED DESCRIPTION OF THE PREFERRED EMBODIMENTS

The preferred embodiments of the present invention will be described below in greater detail with reference to the accompanying drawings. To facilitate understanding, identical reference numerals have been used, where possible, to designate identical or equivalent elements that are common to the Figures without repeating the overlapping descriptions.

First Embodiment

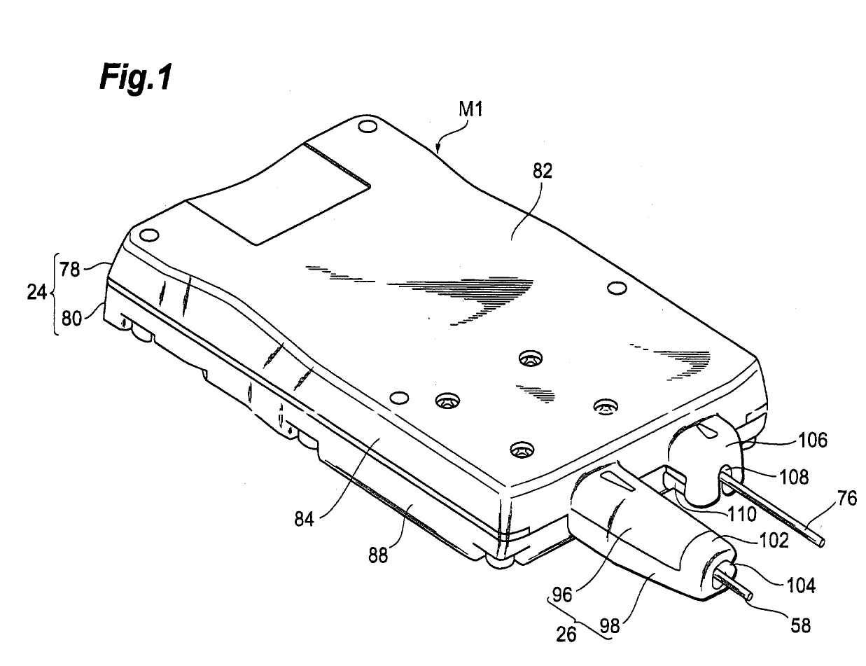

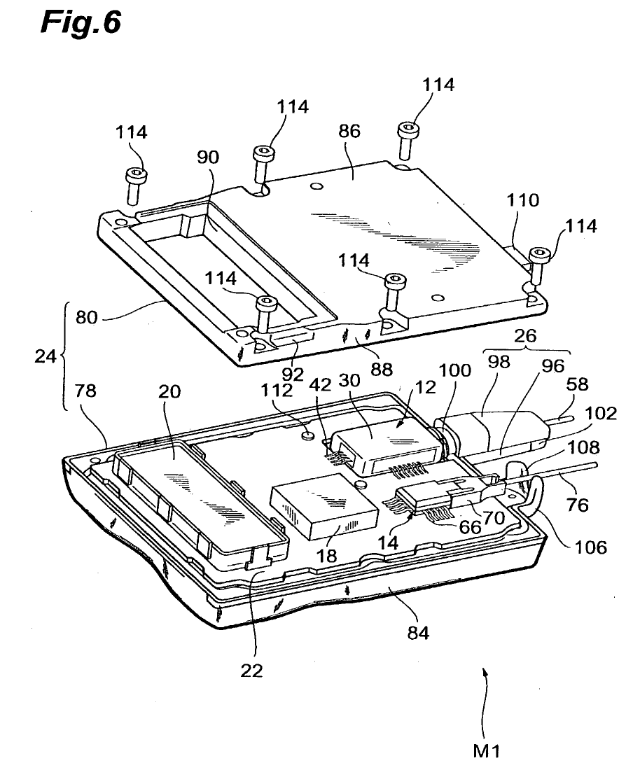

The first embodiment of the present invention will be described with reference to FIG. 1 to FIG. 6. The optical module according to tote present embodiment is an optical transceiver module. FIGS. 1 to 4 are a perspective view, an exploded perspective view, a partial plan view, and a cross-sectional view showing the optical transceiver module M1. FIGS. 5 and 6 are perspective views showing how to assemble the optical transceiver module M1.

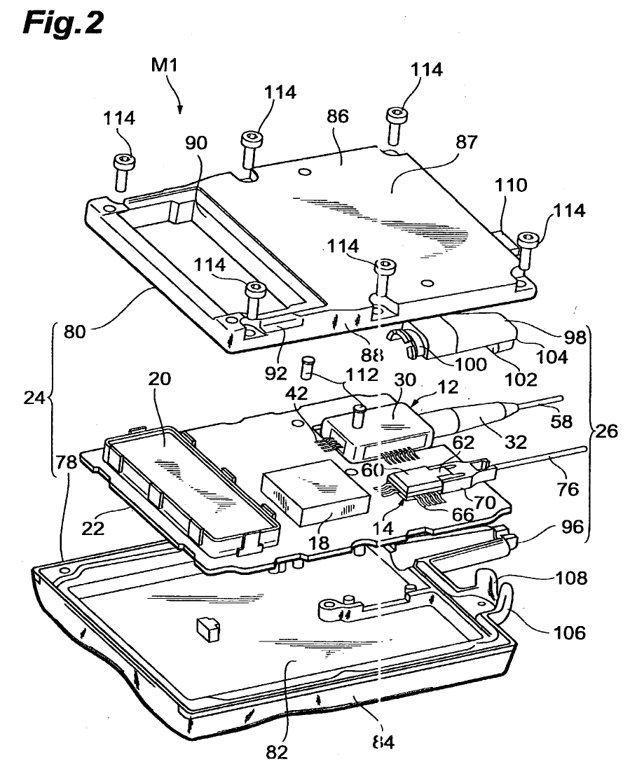

As shown in FIGS. 1 and 2, the optical transceiver module M1 includes a light emitting module 12, a light receiving module 14, a semiconductor circuit element 18, a connector terminal 20, a board 22, a housing 24, a cap 26, and so on.

The light emitting module 12 is a butterfly package type optical module, as shown in FIG. 2. The light emitting module 12 has a device enclosing portion 30 in which a light emitting device is encapsulated, and a fiber connection portion 32. The light emitting module 12 is directed to convert an electric signal into an optical signal.

The device enclosing portion 30 includes a light emitting device such as a semiconductor laser, a light receiving device such as a photodiode, for monitoring the light emitted from the light emitting device, a mounting member for mounting of the light emitting device and the light receiving device, and a housing for enclosing these elements. A plurality of outer leads 42 are provided on side faces of the housing. The mounting member is made of metal such as CuW. The bottom portion of the housing is made of metal such as CuW and the portions other than the bottom portion are made of metal such as KOVAR.

The fiber connection portion 32 includes a lens such as a condenser lens, a lens holding member for holding the lens, a ferrule, a ferrule holder for holding this ferrule, and a rubber boot. An optical fiber 58 is inserted into the ferrule. The ferrule protects one end of the optical fiber 58. The optical fiber 58 is positioned relative to the lens through the ferrule and ferrule holder, whereby it is optically coupled to the light emitting device. The rubber boot covers the lens holding member, the ferrule holder, the ferrule, the holding member, and part of the optical fiber 58. The optical fiber 58 extends through the rubber boot to the outside.

The light receiving module 14 is a surface-mounted type optical module, as shown in FIG. 2. The light receiving module 14 has a device enclosing portion 60 and a fiber connection portion 62. The module 14 is directed to convert an optical signal into an electrical signal.

The device receiving portion 60 is of a structure in which a light receiving device such as a photodiode is encapsulated with resin. A plurality of outer leads 66 are provided on side faces of the device receiving portion 60. These outer leads 66 are bent in order to implement surface mounting.

The fiber connection portion 62 has a structure in which a ferrule with an optical fiber (not shown) inserted thereinto, and a cylindrical sleeve (not shown) holding the ferrule are molded with resin in a state in which one end of the ferrule protrudes therefrom. A pair of side faces of the fiber connection portion 62 have projections to engage with engaging hooks of optical connector plug 70.

The optical connector plug 70 is a plastic connector. When the optical connector plug 70 is attached to the light receiving module 14, the ferrule of the light receiving module 14 is mated with the sleeve (not shown) of the optical connector plug 70. An optical fiber 76 guided from one end of the optical connector plug 70 is inserted through the ferrule (not shown) into the sleeve and positioned therein, thus aligning the center axes of the cores of the two optical fibers with each other.

The semiconductor circuit element 18 is an integrated semiconductor circuit element (e.g., LSI) having BGA (Ball Grid Array). The circuit element 18 is electrically connected to the light emitting module 12 and to the light receiving module 14. The circuit element 18 is directed to output signals for driving and controlling the light emitting module 12, and to shape, amplify, and output signals received by the light receiving module 14.

The connector terminal 20 is a male connector terminal (or a female connector terminal) consisting of BGA and a plurality of lead pins (or receptacles to engage with the lead pins). In this connector terminal 20, a high density terminal is performed by BGA to guide a plurality of signals into and out of the board 22. The connector terminal 20 is coupled to a female connector terminal (or a male connector terminal) on an external board (not shown in FIGS. 1-4) on which the optical transceiver module M1 is mounted. In the present embodiment, the connector terminal 20 and the connector terminal on the external board are so-called zipper type connector terminals. The zipper type connector terminal has a prescribed direction of insertion and removal.

The board 22 has an almost rectangular shape and has printed circuit on the front and back surfaces. The board 22 has a light emitting nodule mounting area, a light receiving module mounting area, a semiconductor-circuit element mounting area, and a connector terminal mounting area on the back surface thereof. Among these, the light emitting module mounting area and light receiving module mounting area are aligned at the front edge of the board 22. The light emitting module mounting area is formed by cutting a portion of the front edge of the board 22 away.

The housing 24 is directed :o enclose the board 22 and is made of metal such as aluminum or copper. Aluminum has advantage in terms of heat conductivity, cost, and so on. The housing 24 consists of an upper part 78 and a lower part 80. The upper part 78 includes a lid 82 extending along the board 22, and a side wall 84 provided at the edge of the lid 82, as shown in FIG. 2.

The lower part 80 includes a base 86 extending along the board 22, and a side wall 88 provided at the edge of the base 86, as shown in FIG. 2. An opening 90 is provided in a portion corresponding to the connector terminal 20 of base 86. The opening 90 is located at the same two-dimensional position as the connector terminal 20 is. The opening 90 has such a size that the connector terminal 20 can be onset in the opening 90.

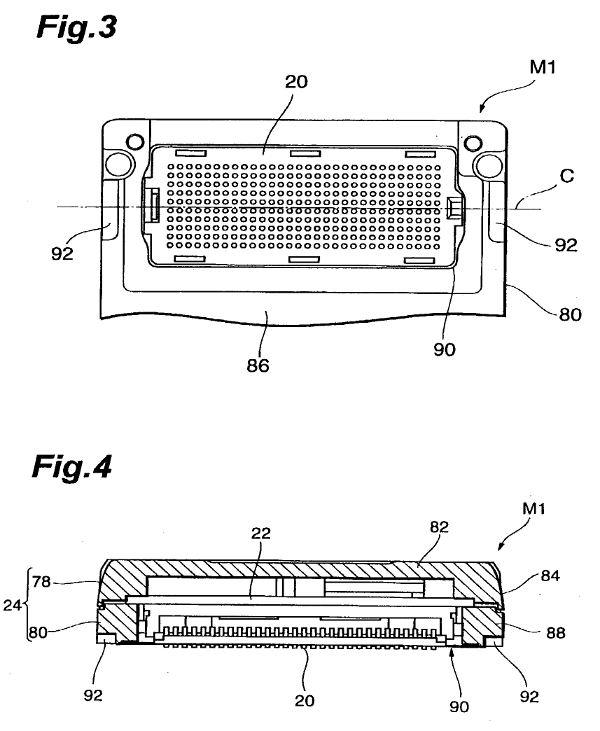

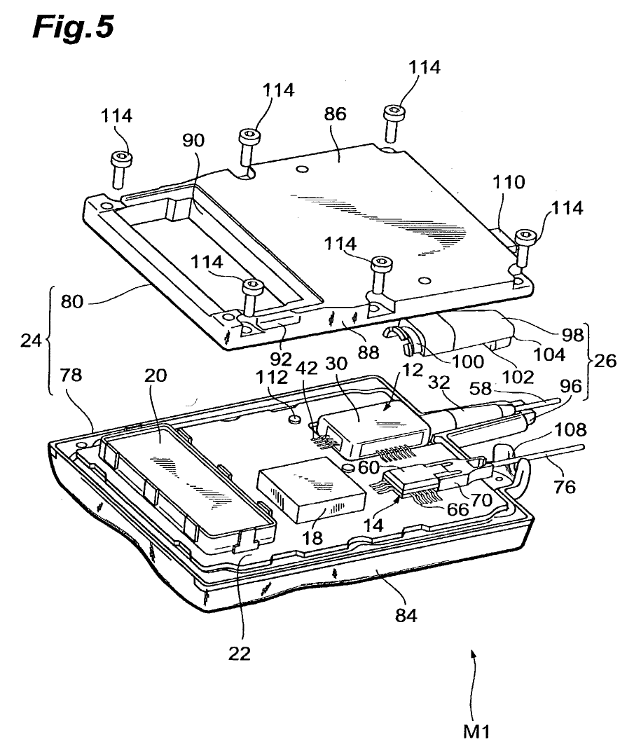

Engageable portions 92, with which an engaging portion of a module removing tool described later is to be engaged, are provided on the sides of the opening 90 in the lower part 80, as also shown in FIGS. 3 and 4. The engageable portions 92 are formed in the bottom surface of the housing 24, i.e., on the periphery of the connector terminal 20 in the bottom surface 87 of the lower part 80. When the optical transceiver module M1 is mounted on the external board, the bottom surface 87 faces the external board. The engageable portions 92 are depressions formed in the base 86 and side wall 88 of the lower part 80.

In the present embodiment, the engageable portions 92 are positioned so that a center line C along the longer side of the connector terminal 20 is approximately identical with a center line of the engageable portions 92. In mounting the optical transceiver module M1 on the external board, the connector terminal 20 is mated with the connector terminal on the external board. The connector terminal 20 is configured so as to be unmated from the connector terminal of the external board along the direction from one end to the opposite end of the connector terminal 20. The center line C is a virtual line extending along this unmating direction. The pair of engageable portions 92 are placed on the opposite sides of the connector terminal 20 on the center line C. Although in the present embodiment the engageable portions 92 are provided on the opposite sides of the opening 90, the module may also be configured so that an engageable portion 92 is provided on only one side according to the direction of insertion and removal of the connector terminal.

The cap 26 is a cylindrical member provided so as to cover the fiber connection portion 32 of the light emitting module 12 and is made of metal such as aluminum or copper. Aluminum is suitable in view of heat conductivity, cost, and so on. The cap 26 is divided along its axial direction. Namely, the cap 26 consists of an upper cap piece 96 and a lower cap piece 98.

The upper cap piece 96 is integral with the side wall 84 of the upper part 78 of the housing. The lower cap piece 98 is separate from the housing 24. This lower cap piece 98 includes an end portion 100 to be sandwiched between the upper part 78 and the lower part 80 of the housing. When the lover cap piece 98 is sandwiched through the end portion 100 between the upper part 78 and the lower part 80 as described above, it can be attached to the housing 24. For this reason, there is no need for an extra work of applying an adhesive or the like, performing wielding, or screwing, so that the productivity of the optical transceiver module M1 is increased.

The lower cap piece 98 has an elastic latch 102 at its distal end. This latch 102 is supported at the distal end of the lower cap piece 98. A gap 104 is provided between the tip of the latch 102 and the distal end of the lower cap piece 98. This gap 104 is provided for allowing the optical fiber 58 of the light emitting module 12 to pass therethrough. The latch 102 latches so as to encompass the distal end of the upper cap piece 96 to fix the upper cap piece 96 and lower cap piece 98. The upper cap piece 96 and the lower cap piece 98 can be fixed through the latch portion 102 in this way. For this reason, there is no need for using an adhesive or the like, performing welding, or screwing. This increases the productivity of the optical transceiver module M1.

A positioning portion 106 for positioning the optical connector plug 70 coupled to the light receiving module 14 is integrally provided in the front side wall 84 of the upper part 78 of the housing. This positioning portion 106 has a glide groove 108 for guiding the optical fiber 76 extending from the optical connector plug 70. A retainer 110 for retaining the optical connector plug 70 positioned by the positioning portion 106 is integrally provided in the front side wall 88 of the lower housing 80.

The light emitting module 12 is mounted in the light emitting module mounting area of the board 22 and the light receiving module 14 is mounted in the light receiving module mounting area of the board 22. The semiconductor circuit element 18 is mounted in the semiconductor circuit element mounting area of the board 22. Furthermore, the connector terminal 20 is mounted in the connector terminal mounting area of the board 22. The board 22 is fixed to the upper part 78 of the housing with screws 112, as shown in FIG. 5. The fiber connection portion 32 of the light emitting module 12 is enclosed in the upper cap piece 96 and the optical connector plug 70 of the light receiving module 14 is positioned by the positioning portion 106.

Furthermore, as shown in FIG. 6, the lower cap piece 98 is coupled through the latch portion 102 to the upper cap piece 96. The lower part 80 of the housing is coupled to the upper pact 78 of the housing with six screws 114. At this time, the lower cap piece 98 is interposed at its end 100 between the upper part 78 of the housing and the lower part 80 of the housing. The optical connector plug 70 is retained and fixed by the retainer 110. The optical transceiver module M1 according to the present embodiment, as shown in FIG. 1, is configured as described above.

In the optical transceiver module M1 of the present embodiment, as described above, the engageable portions 92 to mate with the engaging portion of the module removing tool are provided on the sides of the opening 90 of the lower part 80. Therefore, an appropriate force can be applied to the connector terminal 20 by operating the module removing tool to the engaging portion. As a consequence, it is able to readily remove the optical transceiver module M1 from the external board.

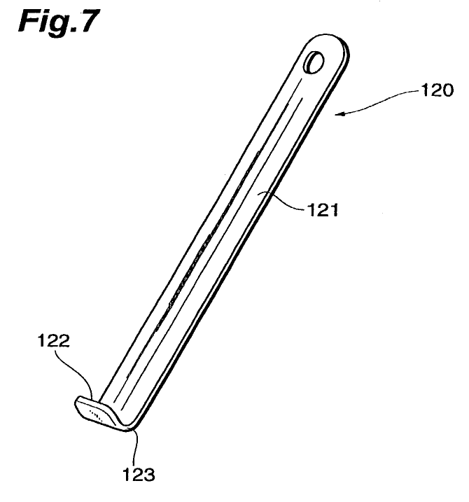

The module removing tool according to the present embodiment will be described below with reference to FIG. 7. FIG. 7 is a perspective view showing the module removing tool.

The module removing tool 120 is an elongated plate made of metal, e.g., stainless steel. The tool 120 has a grip 121. One end 122 of the module removing tool 120 is bent relative to the grip 121. The end 122 is an engaging portion able to engage with the engageable portions 92 of the optical transceiver module M1. In the present embodiment, the engaging portion 122 makes an acute angle with the grip 121. It is noted that the tool 120 does not always have to be limited to a platelike member, but may be a wirelike member. The tool 120 may be made of plastic.

Subsequently, the procedure of removing the optical transceiver module M1 using the module removing tool 120 will be described. The optical transceiver module M1 is mounted on the external board 130.

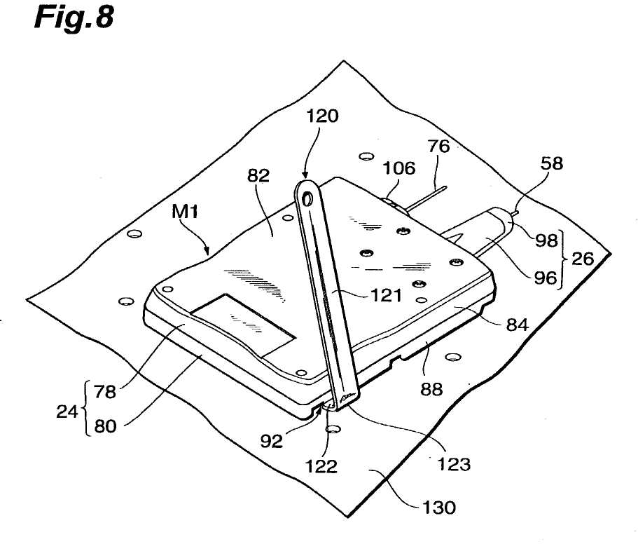

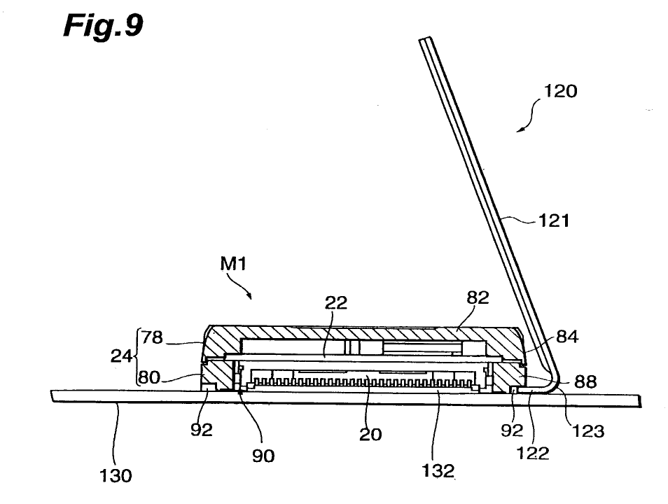

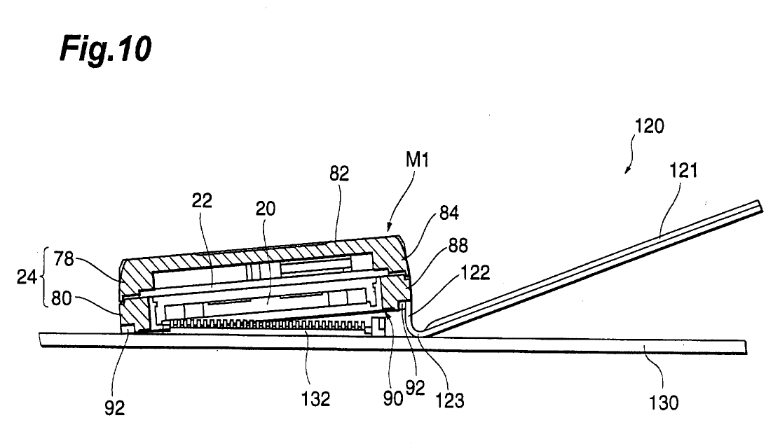

First, as shown in FIGS. 8 and 9, the engaging portion 122 of the module removing tool 120 is inserted into the engageable portion 92 of the housing 24 (lower part 80 of the housing) in the optical transceiver module M1. Thereafter, as shown n FIG. 10, the grip 121 is rotated using the bend 123 in contact with the external board 130 as a fulcrum while the engaging portion 122 is engaged with the engageable portion 92. This lifts the portion of the housing 24 where the engageable portion 92 is formed, from the external board 130. As a result, it is able to detach the connector terminal 20 of the module M1 from the connector terminal 132 of the external board 130.

As described above, the connector terminal 20 of the module M1 can be detached from the connector terminal 132 of the external board 130 by simply rotating one end of the module removing tool 120 while fitting the engaging portion 122 of the tool 120 together with the engageable portion 92 of the optical transceiver module M1. Accordingly, the optical transceiver module M1 can be readily removed from the external board 130.

Second Embodiment

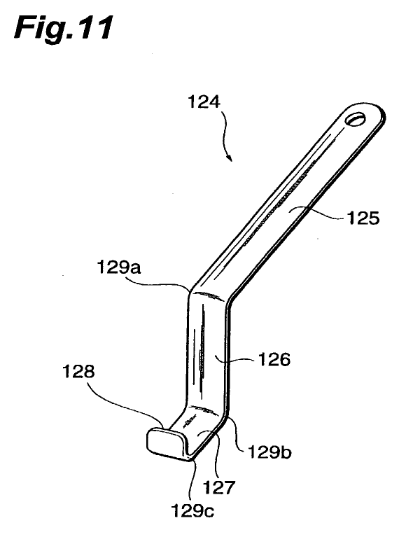

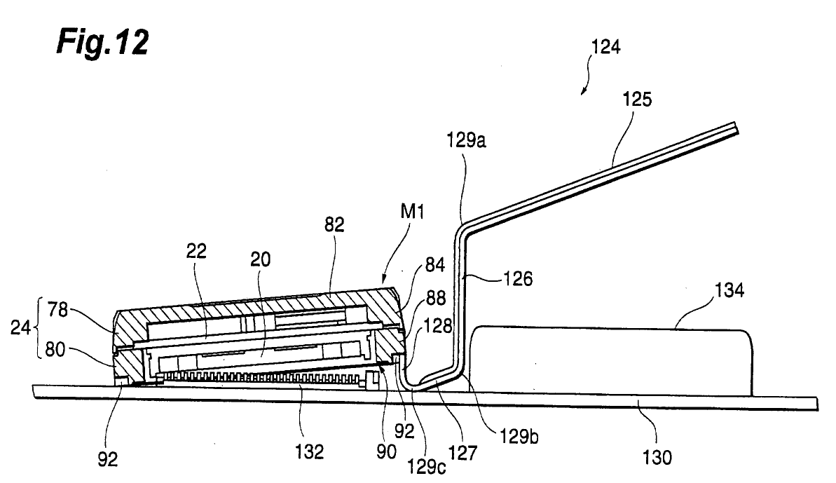

The module removing tool according to the second embodiment will now be described with reference to FIG. 11 and FIG. 12. The module removing tool 124 of the present embodiment is also an elongated plate made of metal, e.g., stainless steel, as in the first embodiment. The tool 124 has a grip 125, a first middle portion 126, a second middle portion 127, and an engaging end 128. The first middle portion 126 extends from the grip 125 and is bent relative to the grip 125. The second middle portion 127 extends from the first middle portion 126 and is bent relative to the first middle portion 126. The engaging end 128 is bent relative to the second middle portion 127. As described above, the tool 124 has the three bends 129a-c.

For removing the aforementioned optical transceiver module M1 from the external board 130, as shown in FIG. 12, the engaging portion 128 of the tool 124 is inserted into the engageable portion 92 of the module M1. Thereafter, the grip 125 is rotated using the bend 129c in contact with the External board 130 as a fulcrum while the engaging portion 128 is engaged with the engageable portion 92. This lifts in lifting the portion of the module M1 where the engageable portion 92 is formed, from the external board 130. As a result, it is able to release the mating between the connector terminal 20 of the module M1 and the connector terminal 132 of the external board 130.

The bends 129a and 129b are formed so as to avoid interference between the tool 124 and a component 134 (e.g., another optical transceiver module) mounted next to the module M1 on the external board 130, in rotating the grip 125 while fitting the engaging portion 128 together with the engageable portion 92 of the module M1. The engaging portion 128 and the second middle portion 127 both have their respective lengths shorter than the gap between the module M1 and the component 134. Therefore, the engaging portion 128 can be inserted into the gap to be fit together with the engageable portion 92 of the module M1. The second middle portion 127 has such a length that the bend 129b is prevented from interfering with the component 134 in rotating the grip 125 using the bend 129c as a fulcrum. This permits the module M1 to be removed from the board 130 without the interference between the component 134 and the module removing tool 124, even that the component 134 is mounted next to the optical transceiver module M1 on the external board 130.

Third Embodiment

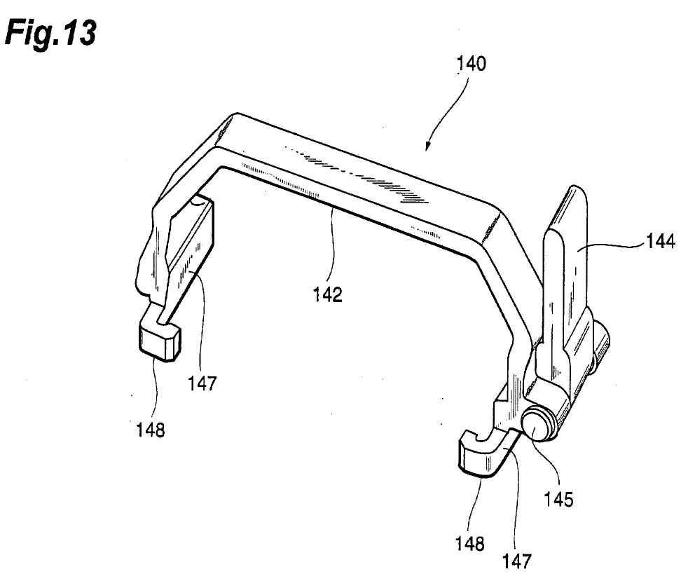

The module removing tool according to the third embodiment will now be described with reference to FIG. 13. FIG. 13 is a perspective vies showing the module removing tool.

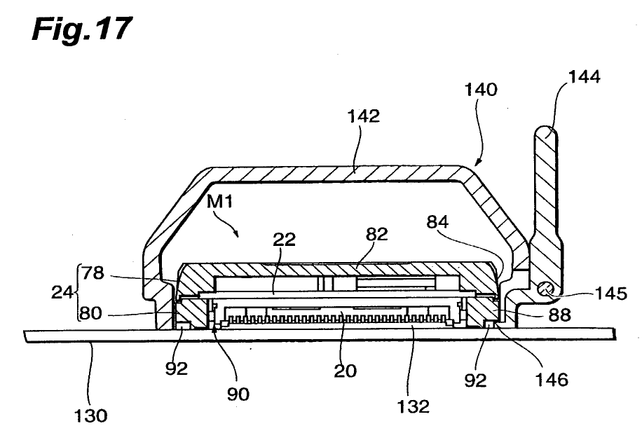

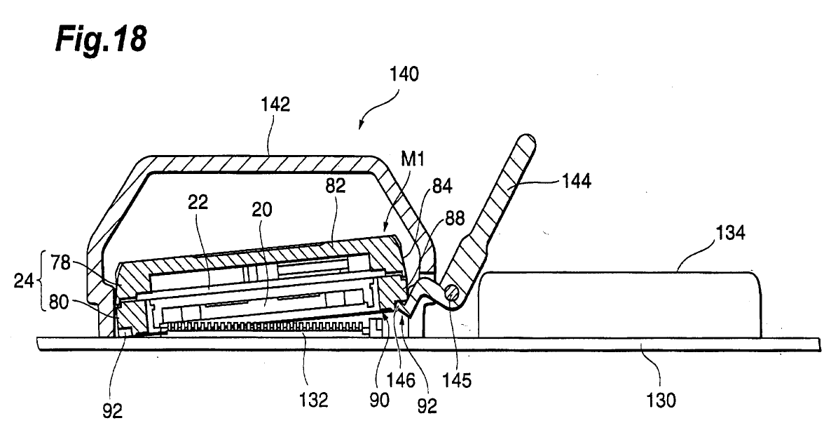

The module removing tool 140 has a base 142 and a lever 144, as shown in FIG. 13. The base 142 has an arch shape. The base 142 is formed so as to straddle the housing 24 of the optical transceiver module M1. Foot portions 147 are provided at the opposite ends of the base 142. In removing the module M1 from the external board 130 using the tool 140, the foot portions 147 are set in contact with the external board 130. This places the base 142 so as to straddle the module M1. A shaft 145 is attached to one end of the base 142. The lever 144 is attached to the base 142 so as to pivot about the shaft 145. The lever 144 includes an engaging portion 146 (shown in FIGS. 17 and 18) able to fit together with, the engageable portion 92 of the aforementioned optical transceiver module M1.

Guide hooks 148, provided at the opposite ends of the base 142, aligns the engaging portion 146 with the engageable portion 92 when the hooks 148 engage with the side wall of the housing 24 (the side wall 88 of the lower part 80 of the housing.) In the present embodiment, a projecting of the hocks 148 from the base 142 is set so that a longitudinal center line C of the connector terminal 20 in FIG. 3 is approximately identical with the center line of the lever 144.

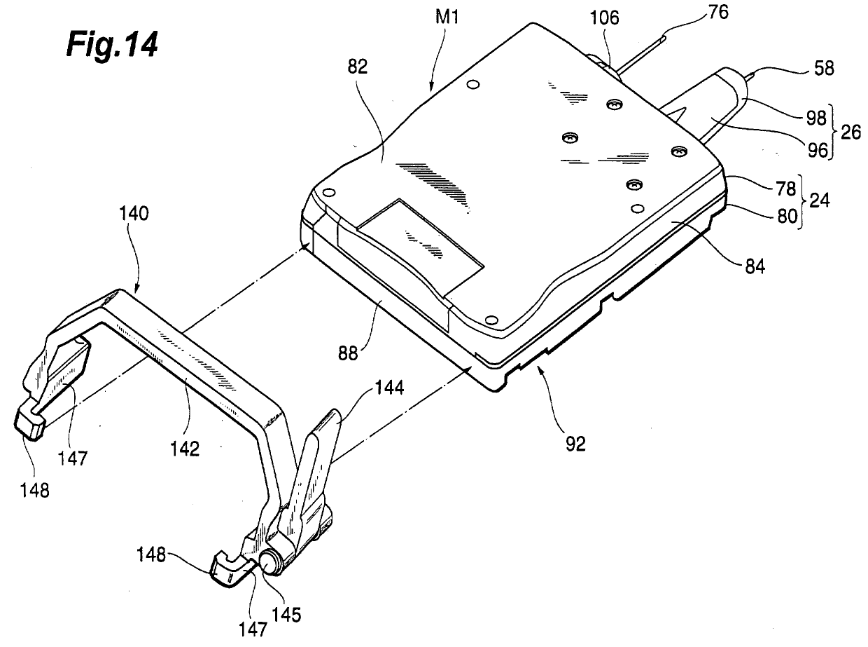

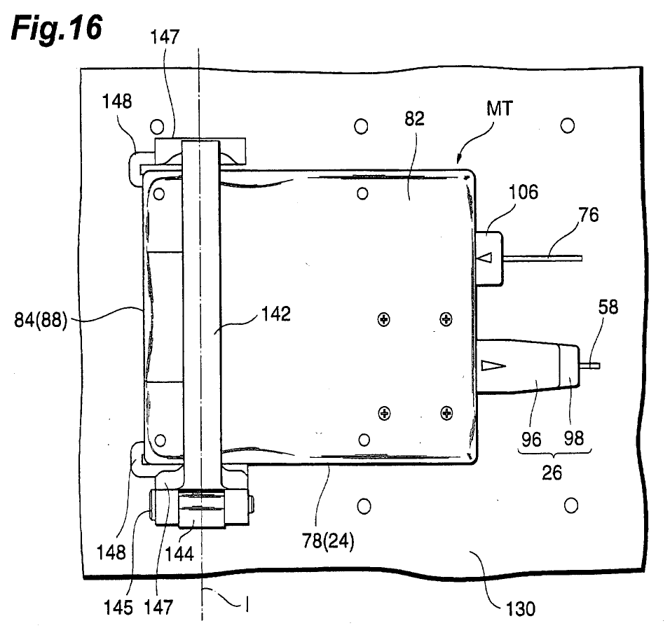

Subsequently, the procedure of removing the optical transceiver module M1 using the module removing tool 140 will be described with reference to FIGS. 14 to 17.

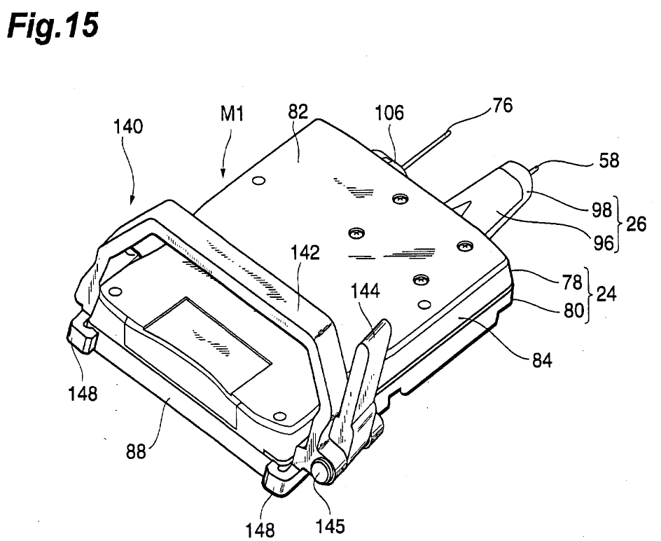

First, as shown in FIG. 14, the module removing tool 140 is fitted to the periphery of the connector terminal 20 in the optical transceiver module M1. Then the hooks 148 are abutted against the side wall of the housing 24 (the side wall 88 of the lower part 80 of the housing) to align the module removing tool 140 (the lever 144) with the connector terminal 20 (the engageable portion 92) of the optical transceiver module M1, as shown in FIGS. 15 to 17. Then, the lever 144 is pivoted to fit the engaging portion 146 together with the engageable portion 92 of the housing 24 (lower part 80 of the housing. Thereafter, as shown in FIG. 18, the lever 144 is pivoted while the engaging portion 146 engages with the engageable portion 92 to lift the housing 24. This releases the mating between the connector terminal 20 of the optical transceiver module M1 and the connector terminal 132 of the external board 130.

In the present embodiment, as described above, the mating between the connector terminals 20 and 132 is released by pivoting the lever 144 while fitting the engaging portion 146 of the lever 144 together with the engageable portion 92 of the housing 24. Accordingly, the optical transceiver module M1 can be readily removed from the external board 130.

In the present embodiment, the engaging portion 146 of the lever 144 is automatically aligned with the connector terminal 20 by the hooks 148 provided in the base 142. Therefore, an appropriate force can be exerted on the connector terminal 20 in removing the optical transceiver module M1 from the external board 130.

In the present embodiment, the optical transceiver module M1 can be removed from the external board 130 by the relatively small pivotal motion of the lever 144. Therefore, even that the component 134 is mounted next to the module M1 or the external board 130, it is easy to avoid the interference between the component 134 and the tool 140 in removing the module M1 from the board 130.

It is noted that the present invention is by no means intended to be limited to the above embodiments but the invention can extend to a variety of changes and modifications. For example, the above embodiments describe the optical transceiver module M1 including both the light emitting module 12 and the light receiving module 14 as an example of the optical module, the optical module may he an optical module only including either a light emitting module or light receiving module.

The light emitting module 12 in the above embodiments is the butterfly package type module, however the light emitting module may be a surface-mounted module. The light receiving module 14 is the surface-mounted module, however the light receiving module may be a butterfly package type module. The semiconductor circuit element 18 way be constructed of separate elements, one for the light emitting module 12 and the other for the light receiving module 14.

In the embodiments, the engageable portions 92 are the depressions in the bottom wall 86 and side wall 88 of the lower housing 80. However, the engageable portions may be protrusions projecting from the side wall 88 of the lower housing 80.

From the invention thus described, it will be obvious that the embodiments of the invention may be varied in many ways. Such variations are not to be regarded as a departure from the spirit and scope of the invention, and all such modifications as would be obvious to one skilled in the art are intended for inclusion within the scope of the following claims.

What is claimed is:

1. An optical module mounted on an external board having a first connector terminal and dismounted from the external board using a module removing tool having an engaging portion, said optical module comprising:
an internal board having a second connector terminal to mate with said first connector terminal; and
a housing for enclosing said internal board, said housing having an opening and are engageable portion provided adjacent to said opening, said second connector terminal passing through said opening, and said engageable portion fitting together with said engaging portion of said module removing tool.

2. An optical module according to claim 1, wherein said second connector terminal is configured to be unmated from said first connector terminal along an unmating direction from one end to an opposite end of said second connector terminal, and
wherein said engageable portion is formed so that said second connector terminal is unmated from said first connector terminal along said unmating direction as one end of said module removing tool is rotated while said engaging portion of said module removing tool fits together with said engageable portion.

3. An optical module according to claim 1, wherein said second connector terminal is configured to be unmated from said first connector terminal along an unmating direction from one end to an opposite end of said second connector terminal, and
wherein said engageable portion is formed on a virtual line extending along said unmating direction through opposite ends of said second connector terminal.

4. An optical module according to claim 3, wherein said virtual line passes a middle of said second connector terminal.

5. An optical module according to claim 3, wherein said optical module comprises a pair of said engageable portions, said pair of engageable portions being placed on said virtual line at opposite sides of said second connector terminal.

6. An optical module according to claim 1, wherein said engageable portion is a depression provided in a surface of said housing.

7. An optical module according to claim 1, wherein said housing includes an upper part and a lower part having a base, said internal board being sandwiched therebetween,
wherein the base of said lower part is brought into contact with said external board when said optical module is mounted on said external board, said second connector terminal passing through said opening, and
wherein said opening is a through hole provided in said base of said lower part.

8. An optical module according to claim 1, wherein said internal board further includes a light emitting module and/or a light receiving module.
